(19) United States
(12) Patent Application Publication
(10) Pub. No.: US 2015/0125028 A1
(43) Pub. Date: May 7, 2015

(54) ELECTRONIC DEVICE AND VIDEO OBJECT MOTION TRAJECTORY MODIFICATION METHOD THEREOF

(71) Applicant: Institute For Information Industry, Taipei (TW)

(72) Inventors: Chia-Wei LIAO, Taipei City (TW); Kai-Hsuan CHAN, Keelung City (TW)

(73) Assignee: Institute For Information Industry, Taipei (TW)

(21) Appl. No.: 14/092,670

(22) Filed: Nov. 27, 2013

(30) Foreign Application Priority Data
Nov. 7, 2013 (TW) 102140432

(51) Int. Cl. G06T 7/20; G06K 9/00

(52) U.S. Cl. CPC G06T 7/20; G06K 9/00711
USPC 382/103

(57) ABSTRACT

An electronic device and a video object motion trajectory modification method thereof are provided. The electronic device includes a video providing unit and a processing unit. The video providing unit is configured to provide a video. The processing unit is configured to extract a video segment from the video. The video segment includes a plurality of successive frames which include a common object. The processing unit is further configured to calculate at least one curve and one control point thereof. The at least one curve corresponds to a motion trajectory of the common object in the successive frames. The processing unit is also configured to adjust the at least one curve via the control point to modify the motion trajectory. The video object motion trajectory modification method is applied to the electronic device to implement the aforesaid operations.

### PRIORITY

This application claims priority to Taiwan Patent Application No. 102140432 filed on Nov. 7, 2013, which is hereby incorporated by reference herein in its entirety.

### FIELD

The present invention relates to an electronic device and a video processing method thereof. More particularly, the present invention relates to an electronic device and a video object motion trajectory modification method thereof.

### BACKGROUND

In recent years, video processing functions have been widely provided in various electronic devices such as television (TV) sets, computers, mobile phones, cameras, video cameras and the like. For example, these electronic devices can generally be used to capture a video, play a video, edit a video and so on.

In some applications, a video object tracking function may increase the added value of an electronic device. For example, in a case of an interactive video, an electronic device having the video object tracking function can estimate a position of an object appearing in each frame of the video so as to embed particular information or a particular link into the object appearing in each of the frames. In this way, when the video is viewed by a user, the user can obtain the particular information or link corresponding to the object by clicking the object appearing in the video directly. In such an application, the electronic device with the video object tracking function can not only save the time of additionally searching the internet, but also facilitate the commodity promotions and event marketing of the manufacturers.

A key factor of the video object tracking technology is how to quickly estimate a motion trajectory of an object in the video, that is, how to quickly estimate variation of the object in the video (which comprises variation in size and position of the object). Owing to advancement of various estimation algorithms, the conventional video object tracking technologies are all able to generally estimate motion trajectories of the object in the video. However, it is inevitable that an error will exist in the estimated video object motion trajectory due to accumulation of the estimation error no matter how accurate the estimation algorithm is adopted. Unfortunately, there is still no effective mechanism to modify the error of the video object motion trajectory estimated by the conventional video object tracking technologies.

Accordingly, an urgent need exists in the art to provide a solution capable of improving the error of the video object motion trajectory estimated by the conventional video object tracking technologies.

### SUMMARY

One primary objective of certain embodiments of the present invention is to improve the error of the video object motion trajectory estimated by conventional video object tracking technologies.

To achieve this objective, certain embodiments of the present invention provide an electronic device. The electronic device comprises a video providing unit and a processing unit electrically connected with the video providing unit. The video providing unit is configured to provide a video. The processing unit is configured to: extract a video segment from the video, wherein the video segment comprises a plurality of successive frames which include a common object; calculate at least one curve and a control point thereof, wherein the at least one curve corresponding to a motion trajectory of the common object in the successive frames; and adjust the at least one curve via the control point to modify the motion trajectory.

To achieve this objective, certain embodiments of the present invention provide a video object motion trajectory modification method for use in an electronic device. The electronic device comprises a video providing unit and a processing unit electrically connected to the video providing unit. The video object motion trajectory modification method comprises the steps of:

(a) providing a video by the video providing unit;

(b) extracting a video segment from the video by the video splitting module, the video segment comprising a plurality of successive frames which include a common object;

(c) calculating at least one curve and a control point thereof by the curve calculating module, the at least one curve corresponding to a motion trajectory of the common object in the successive frames; and

(d) adjusting the at least one curve by the curve adjusting module via the control point to modify the motion trajectory.

Specifically, certain embodiments of the present invention provide an electronic device and a video object motion trajectory modification method thereof. With operations of the video providing unit and the processing unit described above, the electronic device and the video object motion trajectory modification method thereof can fit a motion trajectory of a common object in a video segment into at least one curve and modify the motion trajectory by adjusting a control point of the at least one curve. Accordingly, when an error exists in the motion trajectory, the motion trajectory can be tuned by the electronic device through adjusting the at least one curve directly. Because the aforesaid estimation of the motion trajectory can be implemented by any conventional video object tracking technology, the present invention can effectively improve the error of the video object motion trajectory estimated by the conventional video object tracking technologies.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic structural view of an electronic device 1 according to a first embodiment of the present invention;

FIG. 2A is a diagram illustrating a video object motion trajectory described in the first embodiment of the present invention;

FIG. 2B is a diagram illustrating curves corresponding to the video object motion trajectory according to the first embodiment of the present invention; and

FIG. 3 is a schematic view illustrating a video object motion trajectory modification method according to a second embodiment of the present invention.

### DETAILED DESCRIPTION

In the following description, the present invention will be explained with reference to example embodiments thereof. However, these example embodiments are not intended to limit the present invention to any specific examples, embodiments, environment, applications or particular implementations described in these embodiments. Therefore, description of these example embodiments is only for purpose of illustration rather than to limit the present invention. It should be appreciated that in the following embodiments and the attached drawings, elements unrelated to the present invention are omitted from depiction; and dimensional relationships among individual elements in the attached drawings are illustrated only for ease of understanding, but not to limit the actual scale.

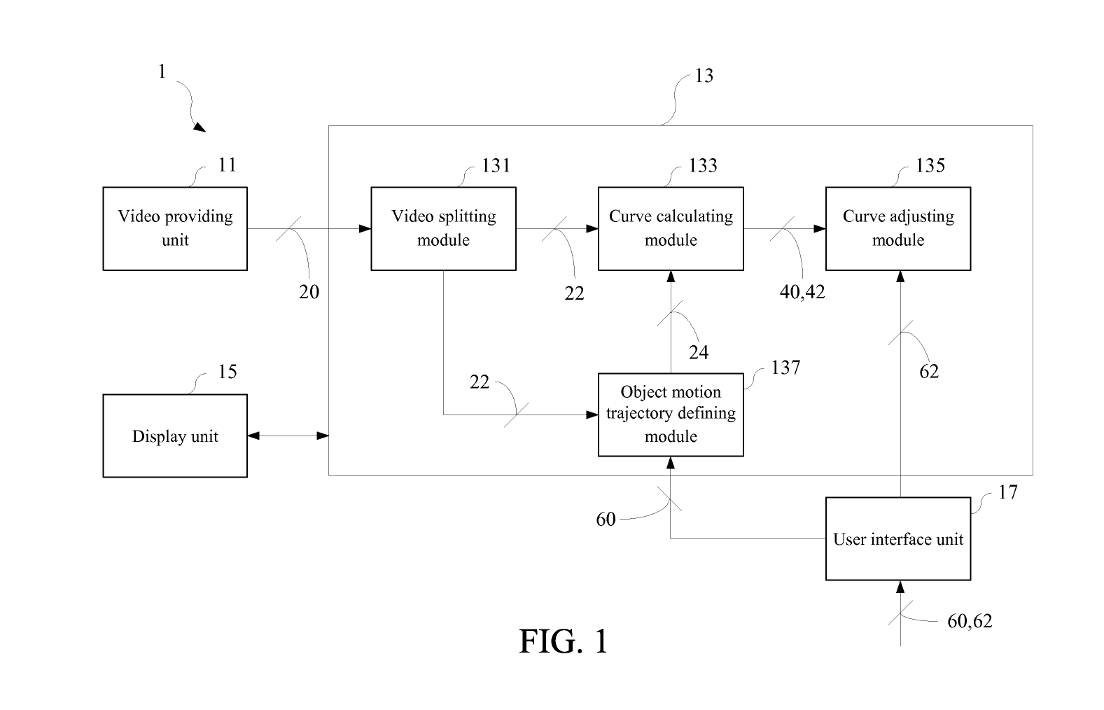

A first embodiment of the present invention is an electronic device. A schematic structural view of electronic device is shown in FIG. 1. As shown in FIG. 1, the electronic device 1 comprises a video providing unit 11, a processing unit 13 and, optionally, a display unit 15 and/or a user interface unit 17. The electronic device 1 may be but is not limited to: a television (TV) set, a computer, a mobile phone, a camera, a video camera and the like. The video providing unit 11, the display unit 15 and the user interface unit 17 are all electrically connected to the processing unit 13, and the individual units can communicate with and transmit messages to/from each other.

The video providing unit 11 may comprise a video capturing device (e.g., a video camera), which is configured to capture a video 20 and provide the video 20 to the processing unit 13. The video providing unit 11 may also comprise a storage, which is configured to store the video 20 and provide the video 20 to the processing unit 13. In other embodiments, the video providing unit 11 may also provide the video 20 to the processing unit 13 in other ways.

The processing unit 13 is configured to extract a video segment 22 from the video 20. The video segment 22 may comprise a plurality of successive frames which include a common object. The processing unit 13 is further configured to calculate at least one curve 40 (i.e., one or more curves 40) and a control point 42 (i.e., one or more control points 42) thereof. The at least one curve 40 corresponds to a motion trajectory 24 of the common object in the successive frames. The processing unit 13 is further configured to adjust the at least one curve 40 via the control point 42 to modify the motion trajectory 24.

The display unit 15 may comprise a screen (e.g., a touch screen or a non-touch screen) to display the at least one curve 40 and the motion trajectory 24 simultaneously. Because the at least one curve 40 and the motion trajectory 24 correspond to each other, the interaction relationships between the at least one curve 40 and the motion trajectory 24 can be observed by the user on the display unit 15. For example, when the display unit 13 adjusts the at least one curve 40 via the control point 42, the user can observe how much the at least one curve 40 is adjusted and how much the motion trajectory 24 is modified simultaneously.

For ease of description, the processing unit 13 of this embodiment may comprise a video splitting module 131, a curve calculating module 133, a curve adjusting module 135 and an object motion trajectory defining module 137. In other embodiments, the processing unit 13 may also be a single processor that executes corresponding operations of the individual modules described above.

As shown in FIG. 1, after a video 20 is received from the video providing unit 11, the video splitting module 131 extracts a video segment 22 from the video 20. As described above, the video segment 22 may comprise a plurality of successive frames which include a common object. The video splitting module 131 is used to ensure that there is at least one common object in the plurality of successive frames comprised in the video segment 22 extracted. Therefore, the video segment 22 may be either the entire video 20 or any segment thereof.

For example, the video splitting module 131 may determine whether the frames are successive according to whether the lens for capturing the video 20 switches. If the frames are not successive, then the video splitting module 131 splits the video 20 and extracts the video segment 22 which comprises a plurality of successive frames. In other embodiments, the processing unit 13 may not comprise the video splitting module 131 and the video providing unit 11 transmits the video 20 directly to the object defining module 133.

The common object is not limited to a specific object, and may be either a live body or a non-live body (e.g., a human being, an animal, a decoration, a vehicle, a tree, a building or the like). Additionally, the common object means that it appears in each of the frames comprised in the video segment 22.

After the video segment 22 has extracted by the video splitting module 131, the object motion trajectory defining module 137 can define the motion trajectory 24 of the common object in the successive frames comprised in the video segment 22. The object motion trajectory defining module 137 may define the motion trajectory 24 according to any conventional video object tracking technology, e.g., the Mean Shift Algorithm, the Continuously Adaptive Mean Shift Algorithm, the Ensemble Tracking Algorithm or the like.

After the video splitting module 131 has extracted the video segment 22 and the object motion trajectory defining module 137 has defined the motion trajectory 24, the curve calculating module 133 can calculate at least one curve 40 (i.e., one or more curves 40) and a control point 42 (i.e., one or more control points 42) thereof. In detail, the curve calculating module 133 may calculate the at least one curve 40 and the control point 42 thereof according to any conventional curve-fitting technology, e.g., the Least Square Algorithm, the Bayesian Fitting Algorithm or the like.

Through use of the curve calculating module 133, the electronic device 1 can fit the motion trajectory 24 of the common object in the successive frames comprised in the video segment 22 into at least one curve 40. In other words, the motion trajectory 24 and the at least one curve 40 are correlated with each other; that is, variation of one of the motion trajectory 24 and the at least one curve 40 will cause corresponding variation of the other. Therefore, the curve adjusting module 135 can adjust the at least one curve 40 via the control point 42 to modify the motion trajectory 24.

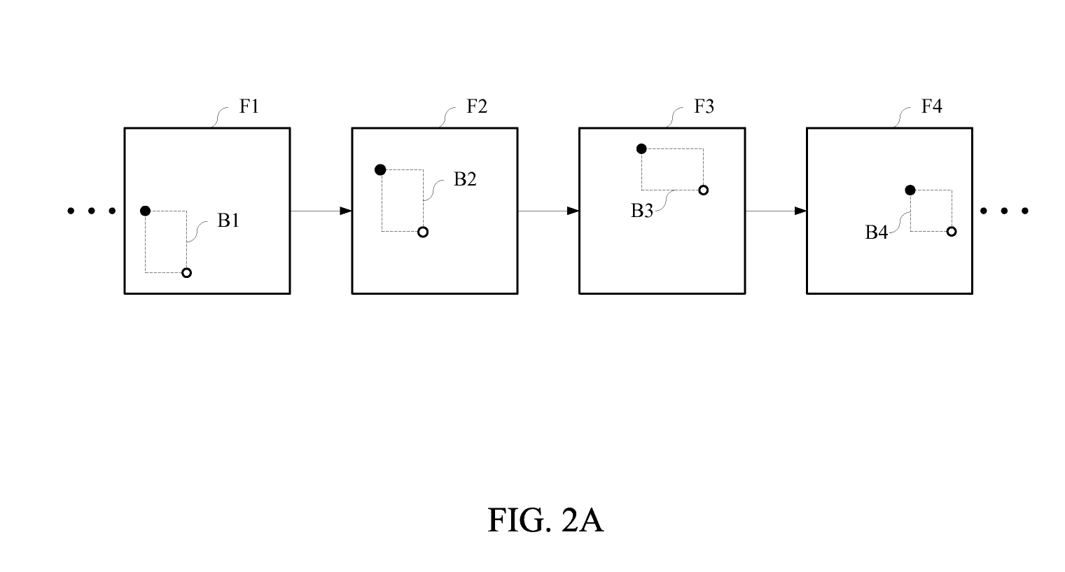

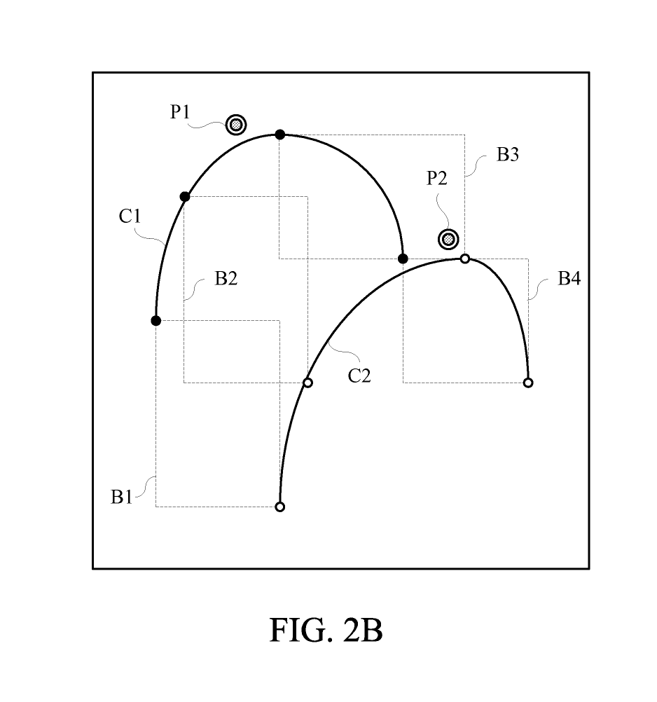

Hereinafter, the aforesaid operations of the curve calculating module 133, the curve adjusting module 135 and the object motion trajectory defining module 137 will be further described by taking FIG. 2A and FIG. 2B as an example. FIG. 2A is a diagram illustrating the motion trajectory 24, and FIG. 2B is a diagram illustrating the at least one curve 40 corresponding to the motion trajectory 24. In this example, the object motion trajectory defining module 137 of the processing unit 13 defines a position of the common object in each of the successive frames comprised in the video segment 22 via a bounding box. Variation (in size and in position) of the bounding boxes in the successive frames forms the motion trajectory 24.

As shown in FIG. 2A, the video segment 22 comprises a plurality of successive frames including a first frame F1, a second frame F2, a third frame F3 and a fourth frame F4. The number of the successive frames is not intended to limit the present invention. The first frame F1, the second frame F2, the third frame F3 and the fourth frame F4 each comprise a common object (not shown), and are boxed by a first bounding box B1, a second bounding box B2, a third bounding box B3 and a fourth bounding box B4 respectively.

As can be known from variation between the first bounding box B1 and the second bounding box B2, the common object varies only in position but not in size between the first frame F1 and the second frame F2. As can be known from variation between the second bounding box B2 and the third bounding box B3, the common object varies not only in position but also in size between the second frame F2 and the third frame F3. As can be known from variation between the third bounding box B3 and the fourth bounding box B4, the common object varies not only in position but also in size between the third frame F3 and the fourth frame F4. In other words, variation from the first bounding box B1, the second bounding box B2, the third bounding box B3 to the fourth bounding box B4 will form a motion trajectory 24 of the common object among the first frame F1, the second frame F2, the third frame F3 and the fourth frame F4.

To reduce the complexity in defining the bounding boxes, the first bounding box B1, the second bounding box B2, the third bounding box B3 and the fourth bounding box B4 may each be defined optionally in such a way that only a first endpoint and a second endpoint thereof along a diagonal direction are presented. As will be readily appreciated by those of ordinary skill in the art, a covering range of each of the bounding boxes can be determined by the two endpoints along the diagonal direction, so this will not be further described herein. As shown in FIG. 2A, the first endpoints of the first bounding box B1, the second bounding box B2, the third bounding box B3 and the fourth bounding box B4 are indicated by solid dots, while the second endpoints of the first bounding box B1, the second bounding box B2, the third bounding box B3 and the fourth bounding box B4 are indicated by hollow dots.

Referring to FIG. 2A and FIG. 2B, the first endpoints (i.e., the solid dots) located in the first bounding box B1, the second bounding box B2, the third bounding box B3 and the fourth bounding box B4 can form a first motion trajectory of the motion trajectory 24, while the second endpoints (i.e., the hollow dots) located in the first bounding box B1, the second bounding box B2, the third bounding box B3 and the fourth bounding box B4 can form a second motion trajectory of the motion trajectory 24.

In this example, the curve calculating module 133 calculates a first curve C1 corresponding to the first motion trajectory and a first control point P1 thereof as well as a second curve C2 corresponding to the second motion trajectory and a second control point P2 thereof. In other words, the curve calculating module 133 fits the first motion trajectory of the motion trajectory 24 into the first curve C1, and fits the second motion trajectory of the motion trajectory 24 into the second curve C2.

When the motion trajectory 24 has an error or is not accurate enough, the curve adjusting module 135 may adjust the first curve C1 via the first control point P1 to modify the first motion trajectory of the motion trajectory 24, and adjust the second curve C2 via the second control point P2 to modify the second motion trajectory of the motion trajectory 24. Thus, the curve adjusting module 135 can effectively modify the motion trajectory 24 to eliminate the error of the motion trajectory 24. How the curves are adjusted via the control points will be readily appreciated by those of ordinary skill in the art, so it will not be further described herein.

In case the electronic device 1 comprises a user interface unit 17, the object motion trajectory defining module 137 of the processing unit 13 may define a position of the common object in each of the successive frames via the bounding box according to a first user input 60 from the user interface unit 17. For example, the first user input 60 may be generated by the user through a display unit 15 (e.g., a touch screen) or through a mouse, a keyboard or any of various input devices (not shown). The first user input 60 may correspond to the user's action of manually boxing the position of the common object in each of the successive frames (if the position of the common body in each of the successive frames has not been defined by a bounding box) or the user's action of manually adjusting the bounding box that boxes the common object in each of the successive frames (if the position of the common object in each of the successive frames has been defined by a bounding box). Next, the object motion trajectory defining module 137 of the processing unit 13 defines a position of the common object in each of the successive frames via the bounding box according to the first user input 60.

On the other hand, the curve adjusting module 135 of the processing unit 13 may also adjust the at least one curve 40 via the control point 42 according to a second user input 62 from the user interface unit 17 so as to modify the motion trajectory 24. For example, the user may move the position of the control point 42 by means of the display unit 15 (e.g., a touch screen) or by means of a mouse, a keyboard or any of various input devices (not shown). Then, the user interface unit 17 generates the second user input 62 according to displacement of the control point 42 caused by the user. Next, the curve adjusting module 135 of the processing unit 13 adjusts the at least one curve 40 according to the second user input 62 from the user interface unit 17 so as to modify the motion trajectory 24.

A second embodiment of the present invention is a video object motion trajectory modification method for use in an electronic device. The video object motion trajectory modification method described in this embodiment may be used in the electronic device 1 described in the first embodiment. Therefore, the electronic device described in this embodiment may be viewed as the electronic device 1 described in the first embodiment. The electronic device described in this embodiment may comprise a video providing unit and a processing unit electrically connected to the video providing unit. The processing unit may comprise a video splitting module, a curve calculating module and a curve adjusting module.

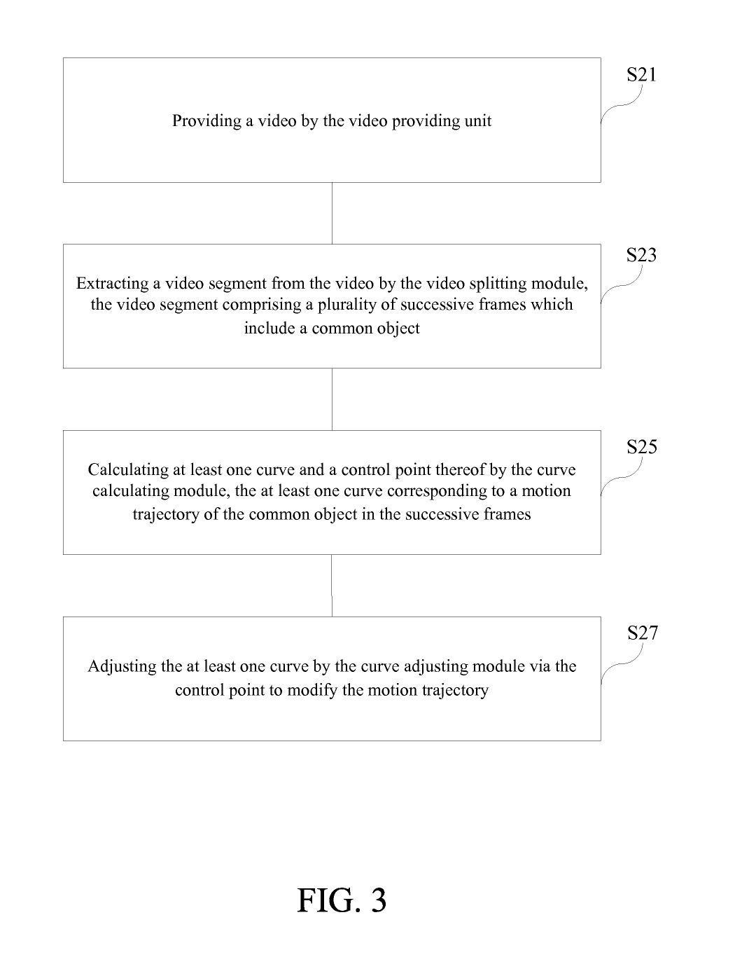

FIG. 3 is a schematic view illustrating the video object motion trajectory modification method. As shown in FIG. 3, the video object motion trajectory modification method comprises the steps S21, S23, S25 and S27, but the order of the steps is not intended to limit the present invention. In the step S21, a video is provided by the video providing unit. In the step S23, a video segment of the video is extracted by the video splitting module. The video segment comprises a plurality of successive frames which include a common object. In the step S25, at least one curve and a control point thereof are calculated by the curve calculating module. The at least one curve corresponds to a motion trajectory of the common object in the successive frames. In step S27, the at least one curve is adjusted by the curve adjusting module via the control point to modify the motion trajectory.

In an example of this embodiment, the processor may further comprise an object motion trajectory defining module, and the video object motion trajectory modification method may optionally further comprise a motion trajectory defining step of: defining a position of the common object in each of the successive frames by the object motion trajectory defining module via a bounding box, wherein displacement of the bounding box in the successive frames form the motion trajectory.

In this example, each of the bounding boxes has a first endpoint and a second endpoint along a diagonal direction, and displacement of the first endpoints and the second endpoints in the successive frames form a first motion trajectory and a second motion trajectory of the motion trajectory respectively. In this case, a first curve and a first control point thereof as well as a second curve and a second control point thereof are calculated by the curve calculating module in the step S25, wherein the first curve and the second curve correspond to the first motion trajectory and the second motion trajectory respectively. Furthermore, the first curve and the second curve are adjusted by the curve adjusting module via the first control point and the second control point respectively to modify the motion trajectory in the step S27.

In this example, the electronic device may optionally further comprises a user interface unit electrically connected to the processing unit. In this case, the motion trajectory defining step is a step of: defining the position of the common object in each of the successive frames by the object motion trajectory defining module via the bounding box according to a first user input from the user interface unit. Optionally in the step S27, the at least one curve is adjusted by the curve adjusting module via the control point according to a second user input from the user interface unit so as to modify the motion trajectory.

In an example of this embodiment, the electronic device may optionally further comprises a display unit electrically connected to the processing unit. In this case, the video object motion trajectory modification method may optionally further comprise the following step of: displaying the at least one curve and the motion trajectory simultaneously by the display unit.

In addition to the aforesaid steps, the video object motion trajectory modification method of this embodiment can further comprise steps corresponding to all operations of the electronic device 1 described in the first embodiment and execute the corresponding functions. Steps undisclosed in this embodiment will be readily appreciated by those of ordinary skill in the art based on the explanation of the first embodiment, and thus will not be further described herein.

According to the above descriptions, the present invention provides an electronic device and a video object motion trajectory modification method thereof. With operations of the video providing unit and the processing unit described above, the electronic device and the video object motion trajectory modification method thereof can fit a motion trajectory of a common object in a video segment into at least one curve and modify the motion trajectory by adjusting a control point of the at least one curve. Accordingly, when an error exists in the motion trajectory, the motion trajectory can be tuned by the electronic device through adjusting the at least one curve directly. Because the aforesaid estimation of the motion trajectory can be implemented by any conventional video object tracking technology, the present invention can effectively improve the error of the video object motion trajectory estimated by the conventional video object tracking technologies.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An electronic device, comprising:
a video providing unit, being configured to provide a video; and
a processing unit electrically connected with the video providing unit and comprising:
a video splitting module, being configured to extract a video segment from the video, the video segment comprising a plurality of successive frames which include a common object;
a curve calculating module, being configured to calculate at least one curve and a control point thereof, the at least one curve corresponding to a motion trajectory of the common object in the successive frames; and
a curve adjusting module, being configured to adjust the at least one curve via the control point to modify the motion trajectory.

2. The electronic device as claimed in claim 1, wherein the processing unit further comprises an object motion trajectory defining module configured to define a position of the common object in each of the successive frames via a bounding box, and displacement of the bounding boxes in the successive frames form the motion trajectory.

3. The electronic device as claimed in claim 2, wherein each of the bounding boxes has a first endpoint and a second endpoint along a diagonal direction, and displacement of the first endpoints and the second endpoints in the successive frames form a first motion trajectory and a second motion trajectory of the motion trajectory respectively; the curve calculating module is further configured to calculate a first curve and a first control point thereof as well as a second curve and a second control point thereof, and the first curve and the second curve correspond to the first motion trajectory and the second motion trajectory respectively; and the curve adjusting module is further configured to adjust the first curve and the second curve via the first control point and the second control point respectively to modify the motion trajectory.

4. The electronic device as claimed in claim 2, further comprising a user interface unit electrically connected to the processing unit, wherein the object motion trajectory defining module defines the position of the common object in each of the successive frames via the bounding box according to a first user input from the user interface unit.

5. The electronic device as claimed in claim 4, wherein the curve adjusting module is further configured to adjust the at least one curve via the control point according to a second user input from the user interface unit to modify the motion trajectory.

6. The electronic device as claimed in claim 1, further comprising a display unit electrically connected to the processing unit, wherein the display unit is configured to display the at least one curve and the motion trajectory simultaneously.

7. A video object motion trajectory modification method for use in an electronic device, the electronic device comprising a video providing unit and a processing unit electrically connected to the video providing unit, the processing unit comprising a video splitting module, a curve calculating module and a curve adjusting module, and the video object motion trajectory modification method comprising the steps of:
(a) providing a video by the video providing unit;
(b) extracting a video segment from the video by the video splitting module, the video segment comprising a plurality of successive frames which include a common object;
(c) calculating at least one curve and a control point thereof by the curve calculating module, the at least one curve corresponding to a motion trajectory of the common object in the successive frames; and
(d) adjusting the at least one curve by the curve adjusting module via the control point to modify the motion trajectory.

8. The video object motion trajectory modification method as claimed in claim 7, wherein the electronic device further comprises an object motion trajectory defining module, and the video object motion trajectory modification method further comprising the step of:
(e) defining a position of the common object in each of the successive frames by the object motion trajectory defining module via a bounding box, wherein displacement of the bounding boxes in the successive frames form the motion trajectory.

9. The video object motion trajectory modification method as claimed in claim 8, wherein:
each of the bounding boxes has a first endpoint and a second endpoint along a diagonal direction, and displacement of the first endpoints and the second endpoints in the successive frames form a first motion trajectory and a second motion trajectory of the motion trajectory respectively;
the step (c) includes:
calculating a first curve and a first control point thereof as well as a second curve and a second control point thereof by the curve calculating module, wherein the first curve and the second curve correspond to the first motion trajectory and the second motion trajectory respectively; and
the step (d) includes:
adjusting the first curve and the second curve by the curve adjusting module via the first control point and the second control point respectively to modify the motion trajectory.

10. The video object motion trajectory modification method as claimed in claim 8, wherein:
the electronic device further comprises a user interface unit electrically connected to the processing unit; and
the step (e) includes:
defining the position of the common object in each of the successive frames by the object motion trajectory defining module via the bounding box according to a first user input from the user interface unit.

11. The video object motion trajectory modification method as claimed in claim 10, wherein the step (d) includes:
adjusting the at least one curve by the curve adjusting module via the control point according to a second user input from the user interface unit to modify the motion trajectory.

12. The video object motion trajectory modification method as claimed in claim 7, wherein:
the electronic device further comprises a display unit electrically connected to the processing unit; and
the video object motion trajectory modification method further comprises the step of:
(f) displaying the at least one curve and the motion trajectory simultaneously by the display unit.
